(19) United States
(12) Patent Application Publication
(10) Pub. No.: US 2024/0429746 A1
(43) Pub. Date: Dec. 26, 2024

(54) Wireless Power System Operable With An Audiovisual Electronic Device

(71) Applicant: Apple Inc., Cupertino, CA (US)

(72) Inventor: Hossein Sepahvand, Santa Clara, CA (US)

(21) Appl. No.: 18/823,466

(22) Filed: Sep. 3, 2024

Related U.S. Application Data
(63) Continuation of application No. 17/349,766, filed on Jun. 16, 2021.
(60) Provisional application No. 63/167,534, filed on Mar. 29, 2021.

(51) Int. Cl. H02J 50/10; H02J 50/00; H02J 50/80; H02J 50/90

(52) U.S. Cl. CPC H02J 50/10; H02J 50/005; H02J 50/80; H02J 50/90; H02J 2310/22

(57) ABSTRACT

A wireless power system may include a wireless power transmitting device and a wireless power receiving device. The wireless power transmitting device may have a wired connection to an audiovisual electronic device. When the wireless power receiving device is attached to the wireless power transmitting device, the audiovisual electronic device may enter a paired mode with the wireless power receiving device. In the paired mode, the wireless power receiving device may control a user interface of the audiovisual electronic device. If the wireless power receiving device is not yet authorized for a paired mode with the audiovisual electronic device, a request for authorization may be displayed for the user in response to the wireless power receiving device being attached to the wireless power transmitting device.

This application is a continuation of non-provisional patent application Ser. No. 17/349,766, filed Jun. 16, 2021, which claims the benefit of provisional patent application No. 63/167,534, filed Mar. 29, 2021, which are hereby incorporated by reference herein in their entireties.

### FIELD

This relates generally to power systems, and, more particularly, to wireless power systems for charging electronic devices.

### BACKGROUND

In a wireless charging system, a wireless power transmitting device such as a charging mat or charging puck wirelessly transmits power to a wireless power receiving device such as a portable electronic device. The portable electronic device has a coil and rectifier circuitry. The coil of the portable electronic device receives alternating-current wireless power signals from the wireless power transmitting device. The rectifier circuitry converts the received signals into direct-current power.

### SUMMARY

A wireless power system has a wireless power transmitting device and a wireless power receiving device. The wireless power transmitting device may include a coil and wireless power transmitting circuitry coupled to the coil. The wireless power transmitting circuitry may be configured to transmit wireless power signals with the coil. The wireless power receiving device may include a coil that is configured to receive wireless power signals from the wireless power transmitting device and rectifier circuitry that is configured to convert the wireless power signals to direct current power.

The wireless power transmitting device may have a wired connection to an audiovisual electronic device. When the wireless power receiving device is attached to the wireless power transmitting device, the audiovisual electronic device may determine if the wireless power receiving device is authorized for a paired mode. If authorized, the audiovisual electronic device may enter a paired mode with the wireless power receiving device. In the paired mode, the wireless power receiving device may transmit an instruction to the audiovisual electronic device to present an audio or visual function supported by the wireless power receiving device or send/receive data.

If the wireless power receiving device is not yet authorized for a paired mode with the audiovisual electronic device, a request for authorization may be displayed for the user. If the user authorizes the paired mode, the wireless power receiving device and the audiovisual electronic device may establish a communication link.

In some cases, the audiovisual electronic device may identify multiple candidate devices for a paired mode where the user interface of the audiovisual electronic device is controlled by an external device. In response to one of the candidate devices being attached to the wireless power transmitting device, the audiovisual electronic device may enter the paired mode with that candidate device.

### BRIEF DESCRIPTION OF THE DRAWINGS

FIG. 1 is a schematic diagram of an illustrative wireless charging system that includes a wireless power transmitting device and a wireless power receiving device in accordance with some embodiments.

FIG. 2 is a circuit diagram of wireless power transmitting and receiving circuitry in accordance with some embodiments.

FIG. 3 is a side view of an illustrative wireless power transmitting device such as a wireless charging puck connected to a connector plug via a cable in accordance with some embodiments.

FIG. 4 is a state diagram of an illustrative audiovisual electronic device that is operable with a wireless charging system in accordance with some embodiments.

FIG. 5 is a flowchart of illustrative operations involved in operating a system where attachment between a wireless power transmitting device and a wireless power receiving device triggers communication between the wireless power receiving device and an audiovisual electronic device in accordance with some embodiments.

FIG. 6 is a flowchart of illustrative operations involved in operating a system where attaching a wireless power transmitting device and a wireless power receiving device triggers a paired mode with the wireless power receiving device and an audiovisual electronic device in accordance with some embodiments.

FIG. 7 is a flowchart of illustrative operations involved in operating a wireless power transmitting device that is operable with a wireless power receiving device and an audiovisual electronic device in accordance with some embodiments.

FIG. 8 is a flowchart of illustrative operations involved in operating an audiovisual electronic device that is operable with a wireless power receiving device and a wireless power transmitting device in accordance with some embodiments.

FIG. 9 is a flowchart of illustrative operations involved in operating a wireless power receiving device that is operable with a wireless power transmitting device and an audiovisual electronic device in accordance with some embodiments.

### DETAILED DESCRIPTION

A wireless power system includes a wireless power transmitting device such as a wireless charging puck. The wireless power transmitting device wirelessly transmits power to a wireless power receiving device such as a cellular telephone, wristwatch, tablet computer, earbud case, or other electronic equipment. The wireless power receiving device uses power from the wireless power transmitting device for powering the device and for charging an internal battery.

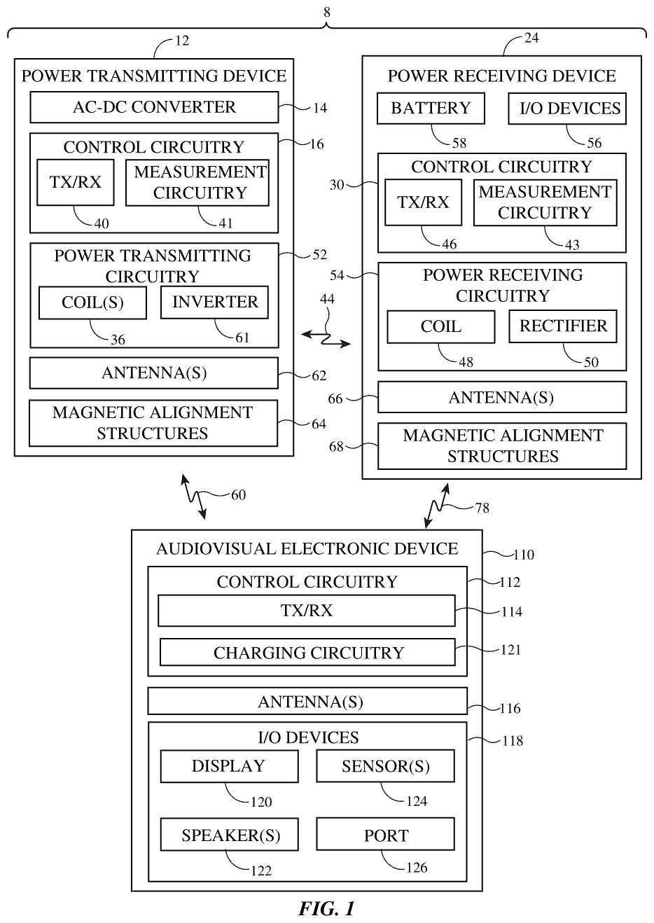

An illustrative wireless power system (wireless charging system) is shown in FIG. 1. As shown in FIG. 1, wireless power system 8 includes a wireless power transmitting device such as wireless power transmitting device 12 and includes a wireless power receiving device such as wireless power receiving device 24. Wireless power transmitting device 12 includes control circuitry 16. Wireless power receiving device 24 includes control circuitry 30. Control circuitry in system 8 such as control circuitry 16 and control circuitry 30 is used in controlling the operation of system 8. This control circuitry may include processing circuitry associated with microprocessors, power management units, baseband processors, digital signal processors, microcontrollers, and/or application-specific integrated circuits with processing circuits. The processing circuitry implements desired control and communications features in devices 12 and 24. For example, the processing circuitry may be used in selecting coils (in embodiments with multiple coils), determining power transmission levels, processing sensor data and other data, processing user input, handling negotiations between devices 12 and 24, sending and receiving in-band and out-of-band data, making measurements, and otherwise controlling the operation of system 8.

Control circuitry in system 8 may be configured to perform operations in system 8 using hardware (e.g., dedicated hardware or circuitry), firmware and/or software. Software code for performing operations in system 8 is stored on non-transitory computer readable storage media (e.g., tangible computer readable storage media) in control circuitry 16 and/or 30. The software code may sometimes be referred to as software, data, program instructions, instructions, or code. The non-transitory computer readable storage media may include non-volatile memory such as non-volatile random-access memory (NVRAM), one or more hard drives (e.g., magnetic drives or solid state drives), one or more removable flash drives or other removable media, or the like. Software stored on the non-transitory computer readable storage media may be executed on the processing circuitry of control circuitry 16 and/or 30. The processing circuitry may include application-specific integrated circuits with processing circuitry, one or more microprocessors, a central processing unit (CPU) or other processing circuitry.

Power transmitting device 12 may be a stand-alone power adapter (e.g., a wireless power transmitting device that includes power adapter circuitry), may be a wireless charging puck or other device that is coupled to a power adapter or other equipment by a cable, may be a portable device, may be equipment that has been incorporated into furniture, a vehicle, or other system, may be a removable battery case, or may be other wireless power transfer equipment. Illustrative configurations in which wireless power transmitting device 12 is a wireless charging puck having a cable with a plug that is adapted to mate with a device such as a power adapter or other electronic equipment with a USB connector port are sometimes described herein as an example.

Power receiving device 24 may be a portable electronic device such as a cellular telephone, wristwatch, tablet computer, or other electronic equipment. Power receiving device 24 may also be a device accessory such as a case (that mates with and holds an additional electronic device such as a cellular telephone or earbuds). Power transmitting device 12 may be coupled to a wall outlet (e.g., an alternating current power source) and may use AC-DC converter to produce direct-current (DC) power and/or may have a battery for supplying power. In some embodiments, which are described herein as an example, AC-DC converter 14 is a stand-alone power converter or is incorporated into a laptop computer or other equipment with a connector port (such as a vehicle). With this type of arrangement, device 12 is separate from the equipment that includes converter 14 and has a cable that plugs into the connector port to receive DC power from converter 14.

The DC power may be used to power control circuitry 16. During operation, a controller in control circuitry 16 uses power transmitting circuitry 52 (sometimes referred to as charging circuitry) to transmit wireless power to power receiving circuitry 54 of device 24. Power transmitting circuitry 52 may have switching circuitry (e.g., inverter circuitry 61 formed from switches such as transistors) that is turned on and off based on control signals provided by control circuitry 16 to create AC current signals through one or more wireless power transmitting coils such as wireless power transmitting coils 36. As an example, coils 36 may be arranged in a planar coil array (e.g., in configurations in which device 12 is a wireless charging mat) or may be arranged to form a cluster of coils (e.g., in configurations in which device 12 is a wireless charging puck). As another example, device 12 may have only a single coil. As another example, device 12 may have multiple coils (e.g., two or more coils, four or more coils, six or more coils, 2-6 coils, fewer than 10 coils, etc.).

As the AC currents pass through one or more coils 36, the coils 36 produce electromagnetic field signals 44 in response to the AC current signals. Electromagnetic field signals (sometimes referred to as wireless power signals) 44 can then induce a corresponding AC current to flow in one or more nearby receiver coils such as coil 48 in power receiving device 24. When the alternating-current electromagnetic fields are received by coil 48, corresponding alternating-current currents are induced in coil 48. Rectifier circuitry such as rectifier circuitry 50, which contains rectifying components such as synchronous rectification metal-oxide-semiconductor transistors arranged in a bridge network, converts received AC signals (received alternating-current signals associated with electromagnetic field signals 44) from one or more coils 48 into DC voltage signals for powering device 24.

The DC voltage produced by rectifier circuitry 50 (sometime referred to as rectifier output voltage Vrect) can be used in charging a battery such as battery 58 and can be used in powering other components in device 24. For example, device 24 may include input-output devices 56. Input-output devices 56 may include input devices for gathering user input and/or making environmental measurements and may include output devices for providing a user with output. As an example, input-output devices 56 may include a display (screen) for creating visual output, a speaker for presenting output as audio signals, light-emitting diode status indicator lights and other light-emitting components for emitting light that provides a user with status information and/or other information, haptic devices for generating vibrations and other haptic output, and/or other output devices. Input-output devices 56 may also include sensors for gathering input from a user and/or for making measurements of the surroundings of system 8. Illustrative sensors that may be included in input-output devices 56 include three-dimensional sensors (e.g., three-dimensional image sensors such as structured light sensors that emit beams of light and that use two-dimensional digital image sensors to gather image data for three-dimensional images from light spots that are produced when a target is illuminated by the beams of light, binocular three-dimensional image sensors that gather three-dimensional images using two or more cameras in a binocular imaging arrangement, three-dimensional lidar (light detection and ranging) sensors, three-dimensional radio-frequency sensors, or other sensors that gather three-dimensional image data), cameras (e.g., infrared and/or visible cameras with respective infrared and/or visible digital image sensors and/or ultraviolet light cameras), gaze tracking sensors (e.g., a gaze tracking system based on an image sensor and, if desired, a light source that emits one or more beams of light that are tracked using the image sensor after reflecting from a user's eyes), touch sensors, buttons, capacitive proximity sensors, light-based (optical) proximity sensors such as infrared proximity sensors, other proximity sensors, force sensors, sensors such as contact sensors based on switches, gas sensors, pressure sensors, moisture sensors, magnetic sensors, audio sensors (microphones), ambient light sensors, optical sensors for making spectral measurements and other measurements on target objects (e.g., by emitting light and measuring reflected light), microphones for gathering voice commands and other audio input, distance sensors, motion, position, and/or orientation sensors that are configured to gather information on motion, position, and/or orientation (e.g., accelerometers, gyroscopes, compasses, and/or inertial measurement units that include all of these sensors or a subset of one or two of these sensors), sensors such as buttons that detect button press input, joysticks with sensors that detect joystick movement, keyboards, and/or other sensors. These components (which form a load for device 24) may be powered by the DC voltages produced by rectifier circuitry 50 (and/or DC voltages produced by battery 58).

Device 12 may optionally have one or more input-output devices (e.g., input devices and/or output devices of the type described in connection with input-output devices 56).

Device 12 and/or device 24 may communicate wirelessly using in-band or out-of-band communications. Device 12 may, for example, have wireless transceiver circuitry 40 that wirelessly transmits out-of-band signals to device 24 using one or more antennas 62. Wireless transceiver circuitry 40 may be used to wirelessly receive out-of-band signals from device 24 using antenna(s) 62. Device 24 may have wireless transceiver circuitry 46 that transmits out-of-band signals to device 12 using one or more antennas 66. Receiver circuitry in wireless transceiver 46 may use the antenna(s) 66 to receive out-of-band signals from device 12. In-band transmissions between devices 12 and 24 may be performed using coils 36 and 48. With one illustrative configuration, frequency-shift keying (FSK) is used to convey in-band data from device 12 to device 24 and amplitude-shift keying (ASK) is used to convey in-band data from device 24 to device 12. Power may be conveyed wirelessly from device 12 to device 24 during these FSK and ASK transmissions.

Out-of-band communications (e.g., using antennas 62 and 66) between power transmitting device 12 and power receiving device 24 may be performed at any desired frequencies. For example, out-of-band communications may be performed using wireless local area network (WLAN) communications bands such as the 2.4 GHz and 5 GHz Wi-Fi® (IEEE 802.11) bands, wireless personal area network (WPAN) communications bands such as the 2.4 GHz Bluetooth® communications band, cellular telephone communications bands such as a cellular low band (LB) (e.g., 600 to 960 MHz), a cellular low-midband (LMB) (e.g., 1400 to 1550 MHz), a cellular midband (MB) (e.g., from 1700 to 2200 MHz), a cellular high band (HB) (e.g., from 2300 to 2700 MHz), a cellular ultra-high band (UHB) (e.g., from 3300 to 5000 MHz, or other cellular communications bands between about 600 MHz and about 5000 MHz (e.g., 3G bands, 4G LTE bands, 5G New Radio Frequency Range 1 (FR1) bands below 10 GHz, etc.), a near-field communications (NFC) band (e.g., at 13.56 MHz), satellite navigations bands (e.g., an L1 global positioning system (GPS) band at 1575 MHz, an L5 GPS band at 1176 MHz, a Global Navigation Satellite System (GLONASS) band, a BeiDou Navigation Satellite System (BDS) band, etc.), ultra-wideband (UWB) communications band(s) supported by the IEEE 802.15.4 protocol and/or other UWB communications protocols (e.g., a first UWB communications band at 6.5 GHz and/or a second UWB communications band at 8.0 GHz), and/or any other desired communications bands. As yet additional examples, transceiver circuitry 40 and transceiver circuitry 46 may support communications at frequencies between about 10 GHz and 300 GHz (e.g., in Extremely High Frequency (EHF) or millimeter wave communications bands between about 30 GHz and 300 GHz and/or in centimeter wave communications bands between about 10 GHz and 30 GHz, sometimes referred to as Super High Frequency (SHF) bands). The communications bands handled by the radio-frequency transceiver circuitry may sometimes be referred to herein as frequency bands or simply as “bands,” and may span corresponding ranges of frequencies.

Control circuitry 16 has external object measurement circuitry 41 that may be used to detect external objects adjacent to device 12 (e.g., on the top of a charging mat or, if desired, to detect objects adjacent to the coupling surface of a charging puck). Circuitry 41 can detect foreign objects such as coils, paper clips, and other metallic objects and can detect the presence of wireless power receiving devices 24 (e.g., circuitry 41 can detect the presence of one or more coils 48). During object detection and characterization operations, external object measurement circuitry 41 can be used to make measurements on coils 36 to determine whether any devices 24 are present on device 12.

In an illustrative arrangement, measurement circuitry 41 of control circuitry 16 contains signal generator circuitry (e.g., oscillator circuitry for generating AC probe signals at one or more probe frequencies, a pulse generator that can create impulses so that impulse responses can be measured to gather inductance information, Q-factor information, etc.) and signal detection circuitry (e.g., filters, analog-to-digital converters, impulse response measurement circuits, etc.). During measurement operations, switching circuitry in device 12 (e.g., in the puck of device 12) may be adjusted by control circuitry 16 to switch each of coils 36 into use. As each coil 36 is selectively switched into use, control circuitry 16 uses the signal generator circuitry of signal measurement circuitry 41 to apply a probe signal to that coil while using the signal detection circuitry of signal measurement circuitry 41 to measure a corresponding response. Measurement circuitry 43 in control circuitry 30 and/or in control circuitry 16 may also be used in making current and voltage measurements (e.g., so that this information can be used by device 24 and/or device 12).

Alignment structures such as magnetic alignment structures 64 and 68 may optionally be included in the system. As shown in FIG. 1, wireless power transmitting device 12 may have magnetic alignment structures 64. Wireless power receiving device 24 may have magnetic alignment structures 68. Each magnetic alignment structure 64 in the transmitting device may magnetically couple with a corresponding magnetic alignment structure 68 in the receiving device. When the transmitter alignment structures 64 are coupled to the receiver alignment structures 68, the transmitting coil(s) 36 may be aligned with the receiving coil(s) 48. Therefore, the magnetic alignment structures ensure proper alignment of the receiving coils relative to the transmitting coils. Magnetic alignment structures 64 and 68 may be permanent magnets (e.g., formed from hard magnetic materials that retain their magnetism over time). The magnetic alignment structures may have any desired shape or arrangement. As one example, the magnetic alignment structures may form a circular ring (e.g., when viewed from above). In some examples, the alignment structures may comprise multiple discrete portions arranged in an arcuate manner such as to form a circular ring. To allow the magnetic alignment structures to easily align coils 36 and 48, coil(s) 36 may be adjacent to magnetic alignment structures 64 and/or coil 48 may be adjacent to magnetic alignment structures 68. As illustrative examples, coil 36 and magnetic alignment structure 64 may be concentric circular rings and/or coil 48 and magnetic alignment structure 68 may be concentric circular rings.

In a possible arrangement, the antennas 62 of power transmitting device 12 include an NFC loop and the antennas 66 of power receiving device 24 include an NFC loop. Power transmitting device 12 and power receiving device 24 may therefore communicate using near-field communication (NFC). When the transmitter alignment structures 64 are coupled to the receiver alignment structures 68, the NFC loop of power transmitting device 12 may be aligned with the NFC loop of power receiving device 24.

Devices 12 and 24 of wireless charging system 8 may also communicate with an audiovisual electronic device such as audiovisual electronic device 110 in FIG. 1. Audiovisual electronic device 110 (sometimes referred to as an audiovisual interface, audiovisual device, audio device, display, etc.) may be an electronic device such as a cellular telephone, a wristwatch, a laptop computer, a desktop computer, a tablet computer, a computer monitor (display), a case that mates with and holds an additional electronic device such as a cellular telephone or earbuds, or other electronic equipment. These examples are merely illustrative. The audiovisual interface 110 may also be a smart speaker, a streaming media player, or an in-car entertainment (ICE) system for a vehicle. In general, the audiovisual electronic device may have audio and/or visual output components.

As shown in FIG. 1, audiovisual electronic device 110 may include control circuitry 112. Control circuitry 112 may be used in controlling the operation of audiovisual electronic device 110. This control circuitry may include processing circuitry associated with microprocessors, power management units, baseband processors, digital signal processors, microcontrollers, and/or application-specific integrated circuits with processing circuits. The processing circuitry implements desired control and communications features in audiovisual electronic device 110.

Control circuitry in audiovisual electronic device 110 may be configured to perform operations in audiovisual electronic device 110 using hardware (e.g., dedicated hardware or circuitry), firmware and/or software. Software code for performing operations in audiovisual electronic device 110 is stored on non-transitory computer readable storage media (e.g., tangible computer readable storage media) in control circuitry 112. The software code may sometimes be referred to as software, data, program instructions, instructions, or code. The non-transitory computer readable storage media may include non-volatile memory such as non-volatile random-access memory (NVRAM), one or more hard drives (e.g., magnetic drives or solid state drives), one or more removable flash drives or other removable media, or the like. Software stored on the non-transitory computer readable storage media may be executed on the processing circuitry of control circuitry 112. The processing circuitry may include application-specific integrated circuits with processing circuitry, one or more microprocessors, a central processing unit (CPU) or other processing circuitry.

Control circuitry 112 may include wireless transceiver circuitry 114 that wirelessly exchanges (e.g., transmits and/or receives) signals with devices 12 and/or 24 using one or more antennas 116. For example, audiovisual electronic device 110 may communicate via a wired or wireless link 60 with power transmitting device 12. Audiovisual electronic device 110 may communicate via a wired or wireless link 78 with power transmitting device 24. Wireless communication between audiovisual electronic device 110 and devices 12 and/or 24 may use any of the frequency bands described above in connection with communication between devices 12 and 24. For example, wireless communication between audiovisual electronic device 110 and devices 12 and/or 24 may use a Bluetooth frequency band or a Wi-Fi frequency band.

Audiovisual electronic device 110 may also include input-output (I/O) devices 118. In general, input-output devices 118 may include input devices for gathering user input and/or making environmental measurements and may include output devices for providing a user with output. For example, audiovisual electronic device 110 may include a display (screen) 120 for presenting visual output, one or more speakers 122 for presenting output as audio signals, light-emitting diode status indicator lights and other light-emitting components for emitting light that presents a user with status information and/or other information, haptic devices for generating vibrations and other haptic output, and/or other output devices. Input-output devices 118 may also include one or more sensors 124 for gathering input from a user and/or for making measurements of the surroundings of audiovisual electronic device 110. Illustrative sensors 124 that may be included in input-output devices 118 include three-dimensional sensors (e.g., three-dimensional image sensors such as structured light sensors that emit beams of light and that use two-dimensional digital image sensors to gather image data for three-dimensional images from light spots that are produced when a target is illuminated by the beams of light, binocular three-dimensional image sensors that gather three-dimensional images using two or more cameras in a binocular imaging arrangement, three-dimensional lidar (light detection and ranging) sensors, three-dimensional radio-frequency sensors, or other sensors that gather three-dimensional image data), cameras (e.g., infrared and/or visible cameras with respective infrared and/or visible digital image sensors and/or ultraviolet light cameras), gaze tracking sensors (e.g., a gaze tracking system based on an image sensor and, if desired, a light source that emits one or more beams of light that are tracked using the image sensor after reflecting from a user's eyes), touch sensors, buttons, capacitive proximity sensors, light-based (optical) proximity sensors such as infrared proximity sensors, other proximity sensors, force sensors, sensors such as contact sensors based on switches, gas sensors, pressure sensors, moisture sensors, magnetic sensors, audio sensors (microphones), ambient light sensors, optical sensors for making spectral measurements and other measurements on target objects (e.g., by emitting light and measuring reflected light), microphones for gathering voice commands and other audio input, distance sensors, motion, position, and/or orientation sensors that are configured to gather information on motion, position, and/or orientation (e.g., accelerometers, gyroscopes, compasses, and/or inertial measurement units that include all of these sensors or a subset of one or two of these sensors), sensors such as buttons that detect button press input, joysticks with sensors that detect joystick movement, keyboards, and/or other sensors.

Input-output devices 118 in audiovisual electronic device 110 may also include a port 126 (sometimes referred to as connector 126 or connector port 126) that is configured to mate with a corresponding connector. Port 126 may be, for example, a USB port (e.g., a USB type-C port, a USB 4.0 port, a USB 3.0 port, a USB 2.0 port, a micro-USB port, etc.) or a multiple-pin connector port.

Control circuitry 112 of audiovisual electronic device 110 may also include charging circuitry 121. The charging circuitry may be configured to provide direct current power to port 126. In this way, the charging circuitry may be able to charge a portable electronic device that is connected to the port. In another possible arrangement, the charging circuitry may provide power to a wireless power transmitting device that in turns provides wireless power signals to a portable electronic device.

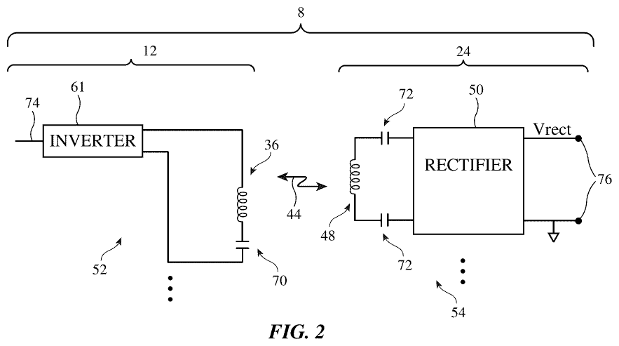

FIG. 2 is a circuit diagram of illustrative wireless charging circuitry for system 8. As shown in FIG. 2, circuitry 52 may include inverter circuitry such as one or more inverters 61 or other drive circuitry that produces wireless power signals that are transmitted through an output circuit that includes one or more coils 36 and capacitors such as capacitor 70. In some embodiments, device 12 may include multiple individually controlled inverters 61, each of which supplies drive signals to a respective coil 36. In other embodiments, an inverter 61 is shared between multiple coils 36 using switching circuitry.

During operation, control signals for inverter(s) 61 are provided by control circuitry 16 at control input 74. A single inverter 61 and single coil 36 is shown in the example of FIG. 2, but multiple inverters 61 and multiple coils 36 may be used, if desired. In a multiple coil configuration, switching circuitry (e.g., multiplexer circuitry) can be used to couple a single inverter 61 to multiple coils 36 and/or each coil 36 may be coupled to a respective inverter 61. During wireless power transmission operations, transistors in one or more selected inverters 61 are driven by AC control signals from control circuitry 16. The relative phase between the inverters can be adjusted dynamically (e.g., a pair of inverters 61 may produce output signals in phase or out of phase (e.g., 180 degrees out of phase).

The application of drive signals using inverter(s) 61 (e.g., transistors or other switches in circuitry 52) causes the output circuits formed from selected coils 36 and capacitors 70 to produce alternating-current electromagnetic fields (signals 44) that are received by wireless power receiving circuitry 54 using a wireless power receiving circuit formed from one or more coils 48 and one or more capacitors 72 in device 24.

If desired, the relative phase between driven coils 36 (e.g., the phase of one of coils 36 that is being driven relative to another adjacent one of coils 36 that is being driven) may be adjusted by control circuitry 16 to help enhance wireless power transfer between device 12 and device 24. Rectifier circuitry 50 is coupled to one or more coils 48 (e.g., a pair of coils) and converts received power from AC to DC and supplies a corresponding direct current output voltage Vrect across rectifier output terminals 76 for powering load circuitry in device 24 (e.g., for charging battery 58, for powering a display and/or other input-output devices 56, and/or for powering other components). A single coil 48 or multiple coils 48 may be included in device 24.

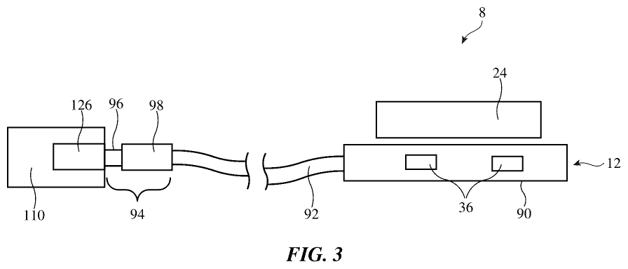

FIG. 3 is a cross-sectional side view of system 8 in an illustrative configuration in which wireless power transmitting device 12 is a wireless charging puck. As shown in FIG. 3, device 12 has a device housing 90 (e.g., a disk-shaped puck housing formed from polymer, other dielectric material, and/or other materials). Device housing 90 may house a device microcontroller for communicating with plug 94, DC-DC power converter circuitry such as a step-down voltage converter (e.g., a buck converter), voltage regulator circuitry such as a low-dropout (LDO) regulator, wireless power transmitting circuitry such as inverter 61 (see FIG. 2), coil(s) 36, and capacitor 70, near-field communications (NFC) circuitry for communicating with power receiving device 24, over-temperature protection (OTP) circuitry such as a temperature sensor, debug circuitry, filter circuitry, magnetic alignment structures 64 (see FIG. 1) for attracting device 24 during charging operations, and/or other power transmitting device components.

Cable 92 is coupled to device housing 90 and provides power to coil(s) 36. One end of cable 92 may be pigtailed to housing 90. The opposing end of cable 92 is terminated using plug 94. Plug 94 has a boot portion 98 sometimes referred to as the “boot” of the plug. Boot 98, which may sometimes be referred to as a connector boot, may be formed from polymer, metal, and/or other materials and may have an interior region configured to house electrical components (e.g., integrated circuits, discrete components such as transistors, printed circuits, etc.). Boot 98 has a first end connected to cable 92 and a second end connected to a connector portion 96 (sometimes referred to as the “connector” of the plug). Connector 96 may include 24 pins, 10-30 pins, 10 or more pins, 20 or more pins, 30 or more pins, 40 or more pins, 50 or more pins, or any suitable number of pins supported within a connector housing. The pins within connector 96 are configured to mate with corresponding pins in port 126 of external equipment such as audiovisual electronic device 110. Audiovisual electronic device 110 may be an in-car entertainment system, a portable electronic device such as a laptop computer, a smart speaker, or any other desired type of system. In some cases, connector 96 may mate with a stand-alone power adapter. Plug 94 having a connector protruding from boot 98 may be referred to as a male plug. Plug 94 can be a reversible plug (i.e., a plug that can be mated with a corresponding connector port in at least two different and symmetrical orientations).

During normal operation of system 8, power receiving device 24 may be placed on the charging surface of power transmitting device 12. The magnetic alignment structures 64 and 68 within devices 12 and 24 attract each other and thereby hold devices 12 and 24 together during charging.

Boot 98 may have a boot housing that houses various electrical components. The boot housing may house a boot microcontroller for communicating with the device microcontroller in housing 90, DC-DC power converter circuitry such as a step-up voltage converter (e.g., a boost converter), voltage regulator circuitry such as a low-dropout (LDO) regulator, electronic fuse circuitry such as an e-fuse or fuse for providing overcurrent protection when detecting short circuits, overloading, mismatched loads, or other device failure events, filter circuitry, and/or other boot components.

In the example of FIG. 3, power transmitting device 12 is formed separately from and connected to audiovisual electronic device 110. In this type of arrangement, charging circuitry 121 in audio (visual electronic device 110 may power coil 36 in power transmitting device 12 by providing direct current power through connector 126. However, this example is merely illustrative. In some cases, power transmitting device 12 may be integrated with audiovisual electronic device 110 (e.g., as a module of audiovisual electronic device 110). In other words, audiovisual electronic device 110 may include a power transmitting module with the components and functionality described in connection with device 12. As an example, the audiovisual electronic device may be an in-car entertainment system with an integrated wireless power transmitting coil. During operation, charging circuitry in the in-car entertainment system may provide direct current power to the wireless power transmitting coil in order to transmit wireless power to a wireless power receiving device.

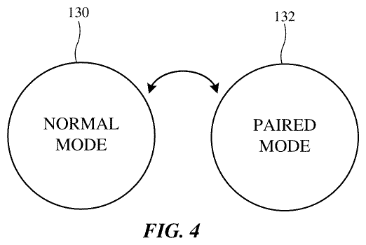

Audiovisual electronic device 110 may have multiple modes of operation. FIG. 4 is a state diagram showing illustrative operating modes for the audiovisual electronic device. The audiovisual electronic device may sometimes operate in a normal mode 130. In the normal mode, audiovisual electronic device 110 may not be paired with an external electronic device. The audiovisual electronic device may sometimes pair with an external electronic device and enter paired mode 132. When in paired mode 132, the audiovisual electronic device may exchange information with the external electronic device (e.g., using a wired or wireless communications link). In the paired mode 132, one or more output devices in the audiovisual electronic device may be controlled using information from the external electronic device. In the paired mode, the audiovisual electronic device may be synced with the external electronic device.

In the normal mode, the audiovisual electronic device may display one or more affordances that represent functions provided by the audiovisual electronic device. An affordance is a user interface element that indicates the actions/results associated with that portion of the user interface. For example, one example of an affordance is a button (e.g., a virtual button on a touch-sensitive display) with a music note icon. When this affordance is displayed on the audiovisual electronic device and selected by the user (e.g., using touch input), the audiovisual electronic device may enter a mode in which music is played. Some non-limiting examples of functions provided by the audiovisual electronic device are operating a radio (e.g., an AM FM radio) or a navigation application. When an affordance for the radio function is selected, the audiovisual electronic device may display the current radio station and/or selectable preset radio stations. When an affordance for the navigation application is selected, the audiovisual electronic device may display a map of a route for the user to follow. The functions provide by the audiovisual electronic device may be self-sufficient (meaning that the functions can be performed in the normal mode without being paired to a separate electronic device).

When the audiovisual electronic device is switched to paired mode 132, the audiovisual electronic device may switch to displaying one or more affordances that represent functions provided by the paired electronic device. For example, a function provided by the paired electronic device may be a music-playing function. An affordance representing the music-playing function may be displayed on the audiovisual electronic device. When selected by the user, music that is stored on the paired electronic device may be wirelessly transmitted to the audiovisual electronic device and played using speakers of the audiovisual electronic device. In general, the functions provided by the paired electronic device require the paired electronic device to operate. In other words, the audiovisual electronic device 110 cannot perform the functions provided by the paired electronic device in normal mode 130 when the audiovisual electronic device 110 is not paired with a separate electronic device.

As one illustrative example that is described herein, audiovisual interface 110 may be an in-car entertainment system. During the normal mode 130, the in-car entertainment system may use native software for operation. The in-car entertainment system is not controlled by a separate device (e.g., cellular telephone) in the normal mode. In-car entertainment system 110 may also be operable in a paired mode 132. In the paired mode, in-car entertainment system 110 may exchange information with and be controlled by a separate device such as a cellular telephone. In-car entertainment system 110 and the paired separate device (e.g., cellular telephone) may operate using a known standard (e.g., CarPlay) in the paired mode.

In paired mode 132, audiovisual interface 110 may operate using information from power receiving device 24. In other words, one or more components in audiovisual interface 110 may be controlled by device 24. Consider the example where audiovisual interface 110 is an in-car entertainment system (sometimes referred to as an infotainment system) and power receiving device 24 is a cellular telephone. While the in-car entertainment system 110 and cellular telephone 24 are connected (e.g., in paired mode 132), the input-output components of in-car entertainment system 110 (e.g., the display, speakers, etc.) may be controlled by cellular telephone 24. For example, a user interface based on the existing home screen in cellular telephone 24 may be provided for the home screen of the in-car entertainment system. In other words, affordances (e.g., buttons and/or icons) from the existing home screen of the cellular telephone may be provided for display on the home screen of the in-car entertainment system. Applications on cellular telephone 24 may be operated using the user interface of in-car entertainment system 110. For example, a navigation application in cellular telephone 24 may operate using the input-output components of in-car entertainment system 110. This allows the in-car entertainment system's display 120 (which may be larger than the cellular telephone display and at a convenient location within the vehicle) to be used for navigation instead of the cellular telephone display. Display 120 may be a touch-sensitive display, and the applications (controlled by the cellular telephone and displayed using the in-car entertainment system) may receive user inputs when the user touches the touch-sensitive display. A music application in cellular telephone 24 may provide music to in-car entertainment system 110 that is played using speakers 122. The in-car entertainment system 110 may be customized using information from the cellular telephone while in the paired mode 132.

Information may be exchanged between the in-car entertainment system 110 and the separate, controlling device (e.g., cellular telephone) using wired or wireless communication. In one possible arrangement, the controlling device (e.g., cellular telephone) may be physically connected to the vehicle (and in-car entertainment system 110) using a cable (e.g., a wired connection). The controlling device provides content to the in-car entertainment system using this wired connection.

In another possible arrangement, the controlling device (e.g., cellular telephone) may be wirelessly connected to the vehicle (and in-car entertainment system 110). The controlling device provides content to the in-car entertainment system using this wireless connection. The wireless connection may use a Bluetooth communications band. Alternatively, to increase the bandwidth of the wireless connection, the wireless connection may use a Wi-Fi communications band such as the 2.4 GHz and/or 5 GHz Wi-Fi communications bands. These examples are merely illustrative. In general, any desired frequency band may be used for wireless communication between the controlling device and the in-car entertainment system.

Consider an example where power receiving device 24 is a cellular telephone, power transmitting device 12 is a wireless charger in a vehicle, and audiovisual interface 110 is an in-car entertainment system in the vehicle.

In some cases, the cellular telephone may be connected directly to audiovisual interface 110 (bypassing wireless charger 12) with a wired connection between the cellular telephone and port 126 of the vehicle. In addition to enabling wired charging, the wired connection between power receiving device 24 and audiovisual interface 110 may also provide a link that enables audiovisual interface 110 to operate using information from the cellular telephone 24 (as discussed above). The in-car entertainment system may operate using information from the cellular telephone (e.g., in the paired mode) while the cellular telephone is physically connected to the vehicle.

Including wireless power transmitting device 12 in the vehicle may make the charging process easier for the user. Instead of plugging in a wire between cellular telephone 24 and the vehicle, the cellular telephone may simply be placed on the wireless charger in the vehicle. The wireless charger may be coupled to port 126 in the vehicle and receive direct current power from the port. This direct current power is used to operate the power transmitting device and transmit wireless power to the cellular telephone. This type of arrangement allows for the user to easily charge cellular telephone 24. However, the wired connection between cellular telephone 24 and in-car entertainment system 110 is no longer present. In-car entertainment system 110 may therefore not know that cellular telephone 24 is present and may not know to enter a paired mode with the cellular telephone.

To improve the user experience and easily link cellular telephone 24 and in-car entertainment system 110, establishment of a wireless charging link between power transmitting device 12 and power receiving device 24 may trigger wireless communication between power receiving device 24 and in-car entertainment system 110. When power receiving device 24 is placed on power transmitting device 12, a wireless charging link is established between devices 24 and 12. Power transmitting device 12 (which has a wired connection to the vehicle) may notify the in-car entertainment system of the presence of the power receiving device 24. This may trigger in-car entertainment system 110 attempting to communicate with power receiving device 24 to establish a link with the power receiving device. Once the link between in-car entertainment system 110 and power receiving device 24 is established, the in-car entertainment system 110 may enter paired mode 132 and be controlled by power receiving device 24.

As a first example, a user may have previously paired their cellular telephone 24 to in-car entertainment center 110 (e.g., ICE 110 has already operated in a paired mode with cellular telephone 24). The cellular telephone 24 is therefore a recognized device for in-car entertainment center 110 and the user has previously authorized cellular telephone 24 to operate in the paired mode with the in-car entertainment system. The user may enter the vehicle and place the cellular telephone 24 on wireless charger 12. In response to detecting the cellular telephone, wireless charger 12 notifies in-car entertainment system 110 of the presence of cellular telephone 24 in the vehicle. In response, in-car entertainment system 110 may enter the paired mode with cellular telephone 24 and start displaying content provided by cellular telephone 24 (e.g., may switch from displaying one or more affordances representing functions provided by the in-car entertainment system to displaying one or more affordances representing functions provided by the cellular telephone).

As a second example, a user may not have previously paired their cellular telephone 24 to in-car entertainment center 110. The cellular telephone 24 is therefore not a recognized device for in-car entertainment center 110 and the user has not yet authorized cellular telephone 24 to operate in the paired mode with the in-car entertainment system. The user may enter the vehicle and place the cellular telephone 24 on wireless charger 12. In response to detecting the cellular telephone, wireless charger 12 notifies in-car entertainment system 110 of the presence of cellular telephone 24 in the vehicle. In response, in-car entertainment system 110 may attempt to establish communications with cellular telephone 24 (and enter the paired mode with cellular telephone 24). The user may be prompted as to whether they would like to pair cellular telephone 24 and in-car entertainment system 110 (e.g., cellular telephone 24 may display a prompt to authorize the pairing). If the user authorizes the pairing, in-car entertainment system 110 may enter the paired mode with cellular telephone 24 and start displaying content provided by cellular telephone 24 (e.g., may switch from displaying one or more affordances representing functions provided by the in-car entertainment system to displaying one or more affordances representing functions provided by the cellular telephone).

As a third example, multiple users may enter the vehicle, each having a cellular telephone that has previously paired with in-car entertainment system 110. In-car entertainment system 110 may identify the presence of the multiple paired cellular telephones (e.g., using wireless communications). However, because multiple paired cellular telephones are present, the in-car entertainment system 110 may not know which of the cellular telephones to use as the controller of the in-car entertainment system. The in-car entertainment system may refrain from entering the paired mode in this scenario (since it is unclear to which device the in-car entertainment system should pair). One of the cellular telephones may then be placed on wireless charger 12. The wireless charger 12 may report which cellular telephone is placed on the charger to in-car entertainment system 110. The in-car entertainment system subsequently enters the paired mode using the cellular telephone that is present on wireless charger. In other words, placing a cellular telephone on the wireless charger serves as an instruction to use that cellular telephone as the controlling device in the paired mode for the in-car entertainment system.

As another example, when multiple in-range electronic devices are present to possibly pair with the in-car entertainment system, the in-car entertainment system may pair with a first one of the devices (e.g., a default device). Then, if a second device of the in-range devices is placed on the wireless charger, the wireless charger 12 may report which device is placed on the charger to in-car entertainment system 110. The in-car entertainment system subsequently terminates the paired mode with the first device and switches to the paired mode with the second device (that is present on wireless charger).

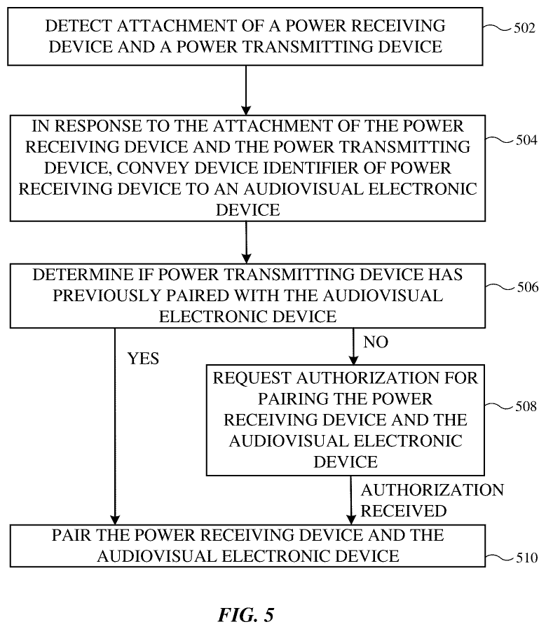

FIG. 5 is a flowchart of illustrative operations involved in operating a system where attachment between a wireless power transmitting device and a wireless power receiving device triggers communication between the wireless power receiving device and an audiovisual electronic device. As shown, at step 502, attachment may be detected between a power receiving device and a power transmitting device. When the power receiving device 24 and the power transmitting device 12 are attached, the magnetic alignment structures 64 and 68 may be magnetically coupled and coils 36 and 48 may be aligned. In this configuration, the power transmitting device 12 may transfer wireless power to power receiving device 24.

There are many ways to detect the attachment between power transmitting device 12 and power receiving device 24. The power transmitting device 12 and/or the power receiving device 24 may include sensors or other components that enable the attachment of power transmitting device 12 and power receiving device 24 to be detected. As previously discussed in connection with FIG. 1, external object measurement circuitry 41 in power transmitting device 12 can be used to make measurements on coils 36 to determine whether any devices 24 are present on device 12. External object measurement circuitry 41 may therefore detect the attachment between power transmitting device 12 and power receiving device 24.

Alternatively or in addition, one or more components in wireless power receiving device 24 may detect the attachment between power transmitting device 12 and power receiving device 24. Power receiving device 24 may include an NFC loop and/or a magnetic sensor (e.g., a Hall effect sensor) that are used to detect attachment of device 24 to device 12. For example, a magnetic sensor in power receiving device 24 may detect the presence of device 12 when device 24 is positioned adjacent to device 12. In response to the magnetic sensor being triggered, the NFC loop in power receiving device 24 may attempt to communicate with a corresponding NFC loop in power transmitting device 12.

The aforementioned examples of detecting attachment between power transmitting device 12 and power receiving device 24 are merely illustrative. In general, any desired sensors in one or both of devices 12 and 24 may be used to detect the attachment. Magnetic sensors (e.g., a Hall effect sensor), optical sensors (e.g., a camera, proximity sensor, etc.), measurement circuitry coupled to coil 36 and/or 48, or any other desired type of sensor may be included in devices 12 and 24 and used to help detect the attachment. Additionally, one or more sensors may also be included in audiovisual electronic device 110 to detect the attachment between devices 12 and 24. In the example where audiovisual electronic device 110 is an in-car entertainment system, the in-car entertainment system may include one or more sensors such as magnetic sensors (e.g., a Hall effect sensor) and/or optical sensors (e.g., a camera, proximity sensor, etc.) to help detect the attachment between devices 12 and 24.

After detecting the attachment of the power receiving device and the power transmitting device, power transmitting device 12 may negotiate a power transfer rate with power receiving device 24 and begin delivering wireless power to power receiving device 24. Additionally, at step 504, a device identifier for the power receiving device may be conveyed to audiovisual electronic device 110. As discussed in connection with FIG. 1, the audiovisual electronic device may be an in-car entertainment system. Alternatively, the audiovisual electronic device may be an electronic device such as a laptop computer, tablet computer, desktop computer, smart speaker, etc.

There are several ways in which the device identifier of the power receiving device may be conveyed to audiovisual electronic device 110. In one possible configuration, power receiving device 24 may transmit the device identifier to power transmitting device 12 using in-band communication. Power transmitting device 12 subsequently relays the device identifier to audiovisual electronic device 110. In other words, while wireless power is being delivered from power transmitting device 12 to power receiving device 24, power receiving device 24 may transmit one or more packets (with the device identifier) to device 12 using coil 48 (e.g., using amplitude-shift keying). Device 12 may receive the device identifier in-band (e.g., using coil 36).

As previously mentioned, device 12 may have a wired link 60 to audiovisual electronic device 110. As shown in FIG. 3, for example, power transmitting device 12 may have a connector 96 that mates with a corresponding port 126 in audiovisual electronic device 110. The wired connection between power transmitting device 12 and audiovisual electronic device 110 may allow power transmitting device 12 to receive direct current power from audiovisual electronic device 110. Additionally, the wired connection between power transmitting device 12 and audiovisual electronic device 110 may allow power transmitting device 12 to send information such as the device identifier to audiovisual electronic device 110.

Audiovisual electronic device 110 may therefore receive a device identifier for power receiving device 24 via a wired connection with power transmitting device 12. This example is merely illustrative. In another possible configuration, audiovisual electronic device 110 may receive a device identifier for power receiving device 24 directly from power receiving device 24 (e.g., using antenna 116 and out-of-band communication).

In other words, power receiving device 24 and audiovisual electronic device 110 may have a wireless link 78 that allows communication between power receiving device 24 and audiovisual electronic device 110. Power receiving device 24 may use antenna 66 to transmit its device identifier to audiovisual electronic device 110 (e.g., in a Bluetooth or Wi-Fi communications band). Audiovisual electronic device 110 may use antenna 116 to receive the device identifier.

To summarize, the device identifier may be conveyed from power receiving device 24 to audiovisual electronic device 110 at step 504 in at least two ways. A first option is for the device identifier to be transmitted from power receiving device 24 to power transmitting device 12 using in-band communication (e.g., using coils 36 and 48). The device identifier is then provided audiovisual electronic device 110 using a wired connection between power transmitting device 12 and audiovisual electronic device 110. A second option is for the device identifier to be transmitted directly from power receiving device 24 to audiovisual electronic device 110 using out-of-band communication (e.g., using antennas 66 and 116).

In the first option, power transmitting device 12 may transmit a request to device 24 to trigger device 24 to send its device identifier to power transmitting device 12 in-band (so that power transmitting device 12 can in turn relay the device identifier to audiovisual electronic device 110). As another option, device 24 may receive information from device 12 indicating that device 12 is connected to or otherwise in close proximity to an additional audiovisual electronic device that may wish to (or be able to) pair with a power receiving device 24. Device 24 may transmit its device identifier to device 12 in response to this information. Alternatively, in some wireless power delivery schemes, power receiving device 24 may automatically transmit its device identifier to device 12 as part of the identification phase of the wireless power communication protocol. Power transmitting device 12 can in turn relay the device identifier to audiovisual electronic device 110.

In the second option, power transmitting device 12 may transmit a request to device 24 to trigger device 24 to send its device identifier to audiovisual electronic device 110 out-of-band. Alternatively, device 24 may receive information from device 12 indicating that device 12 is connected to or otherwise in close proximity to an audiovisual electronic device that may wish to (or be able to) pair with a power receiving device 24. Device 24 may transmit its device identifier to audiovisual electronic device 110 directly (e.g., using antenna 66) in response to this information.

It should be noted that, prior to steps 502 and 504, power transmitting device 12 may have exchanged information with audiovisual electronic device 110. For example, when the wired connection between power transmitting device 12 and audiovisual electronic device 110 is established, power transmitting device 12 and audiovisual electronic device 110 may exchange information such as device type, power delivery capabilities, etc. The power transmitting device 12 may receive information from audiovisual electronic device 110 identifying that audiovisual electronic device 110 is an in-car entertainment system or other device that may wish to (or be able to) pair with a power receiving device 24. Thus, when attachment between power receiving device 24 and power transmitting device 12 is detected at step 502, power transmitting device 12 and/or power receiving device 24 knows to proceed to step 504 (and ensure the device identifier is conveyed to the audiovisual electronic device 110).

At step 506, the audiovisual electronic device 110 may receive the device identifier 24 and determine if the power receiving device 24 has previously paired with audiovisual electronic device 110. The audiovisual electronic device may maintain a list of previously paired devices (e.g., a list of authorized device identifiers). If the received device identifier is on the list of authorized device identifiers, the audiovisual electronic device 110 may proceed to step 510 and pair with power receiving device 24.

At step 510, there are many options for how to pair the power receiving device 24 and audiovisual electronic device 110. Audiovisual electronic device 110 may transmit a pairing request directly do device 24 using antennas 116 and 66 (e.g., using Bluetooth or Wi-Fi communications bands). Alternatively, audiovisual electronic device 110 may send a pairing request to device 24 using device 12 as a relay. In other words, audiovisual electronic device 110 may provide the pairing request to device 12 using the wired connection between audiovisual electronic device 110 and device 12. Device 12 may then transmit the pairing request to device 24 using in-band communication (e.g., frequency-shift keying that occurs while power is delivered from device 12 to device 24). In response to receiving the pairing request, device 24 may trigger antenna 66 to communicate with antenna 116 of audiovisual electronic device 110. Triggering antenna 66 to communicate with antenna 116 may involve scanning various frequency bands to identify a frequency band of communication with audiovisual electronic device 110 and/or transmitting signals with antenna 66 to establish a wireless link with audiovisual electronic device 110.

At step 506, if the received device identifier is not on the list of authorized device identifiers, the audiovisual electronic device 110 may proceed to step 508. At step 508, authorization may be requested from a user for pairing power receiving device 24 and audiovisual electronic device 110. The authorization may be requested using the input-output components of power receiving device 24 and/or audiovisual electronic device 110. As one example, the request for authorization may be displayed on a display in audiovisual electronic device 110. Alternatively, the request for authorization may be displayed on a display in power receiving device 24.

If the user declines the request for pairing power receiving device 24 and audiovisual electronic device 110, power receiving device 24 and audiovisual electronic device 110 may cease any communication and power receiving device 24 simply receives wireless power from power transmitting device 12. If the user authorizes the request for pairing power receiving device 24 and audiovisual electronic device 110, power receiving device 24 and audiovisual electronic device 110 may be paired at step 510 as previously discussed.

Pairing the power receiving device 24 and audiovisual electronic device 110 at step 510 may establish a communications link between power receiving device 24 and audiovisual electronic device 110. The communications link may be a wireless communications link between power receiving device 24 and audiovisual electronic device 110 (similar to as previously described). Alternatively, the communications link may include communication between devices 12 and 24 using coils 36 and 48 (e.g., in-band communication) and communication between device 12 and 110. In other words, the ongoing communications link between device 24 and audiovisual electronic device 110 may use device 12 as a relay.

There are many ways in which the communications link may be used. For example, consider the example where audiovisual electronic device 110 is an in-car entertainment system. After the power receiving device 24 and in-car entertainment system 110 are paired, in-car entertainment system 110 may enter paired mode 132. Power receiving device 24 transmits instructions and/or data to in-car entertainment system 110 that is used to control the user interface of in-car entertainment system 110. For example, in-car entertainment system 110 may display content on a display that is provided by power receiving device 24 over the wireless link.

At step 510, in accordance with detecting alignment of the power receiving device 24 with the power transmitting device 12 for wireless power transmission, control circuitry within power receiving device 24 may transmit an instruction to the audiovisual electronic device 110 to present an audio or visual function supported by power receiving device 24. Alternatively, in accordance with detecting alignment of the power receiving device 24 with the power transmitting device 12 for wireless power transmission, control circuitry within power receiving device 24 may send or receive information.

Consider another example where audiovisual electronic device 110 is a laptop or desktop computer. After the power receiving device 24 and computer 110 are paired, power receiving device 24 and computer 110 may be synced. For example, photos taken on power receiving device 24 may be sent from power receiving device 24 to computer 110 using the communications link and saved on computer 110. Music or television shows downloaded on computer 110 may be sent from computer 110 to power receiving device 24 using the wireless link and saved on power receiving device 24.

The steps outlined in FIG. 5 enable a power receiving device 24 to automatically pair with (and send instructions to) an audiovisual electronic device in response to being placed on a power transmitting device 12 that is coupled to the audiovisual electronic device. This enables functionality such as, in response to device 24 being attached to wireless charger 12, automatically entering a paired mode where power receiving device 24 controls in-car entertainment system 110 or automatically syncing power receiving device 24 and a computer 110. However, in some cases a user may wish to disable this type of functionality. Therefore, a user-controllable setting may be present (e.g., on power receiving device 24, power transmitting device 12, and/or audiovisual electronic device 110) that enables the user to selectively enable and disable the automatic pairing and subsequent functionality.

Consider the example where system 110 is an in-car entertainment system. In-car entertainment system 110 may have a setting such as “automatically enter paired mode with wirelessly charging devices” that can be toggled on and off by the user using the input-output components 118. Alternatively or in addition, device 24 may have a setting such as “automatically enter paired mode with available in-car entertainment systems while wirelessly charging” that can be toggled on and off by the user using the input-output components 56.

Consider the example where audiovisual electronic device 110 is a laptop or desktop computer. Computer 110 may have a setting such as “automatically sync with wirelessly charging devices” that can be toggled on and off by the user using the input-output components 118. Alternatively or in addition, device 24 may have a setting such as “automatically sync with available computers while wirelessly charging” that can be toggled on and off by the user using the input-output components 56.

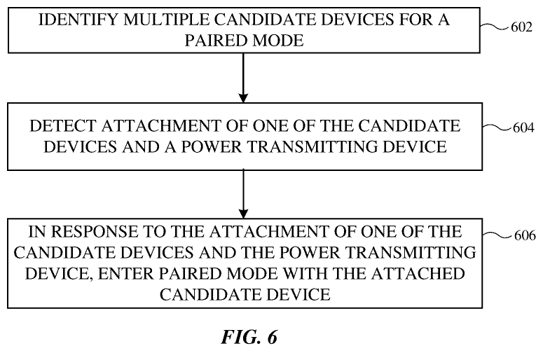

FIG. 5 shows one example of how attachment between a power receiving device and power transmitting device may trigger additional steps associated with an audiovisual electronic device. Another example of this type of functionality is shown in FIG. 6.

FIG. 6 is a flowchart of illustrative operations involved in operating a system where attaching a wireless power transmitting device and a wireless power receiving device triggers a paired mode with the wireless power receiving device and an audiovisual electronic device. As shown in FIG. 6, at step 602, multiple candidates for a paired mode with audiovisual electronic device 110 may be detected.

As an example for step 602, consider a scenario where audiovisual electronic device 110 is an in-car entertainment system 110. In-car entertainment system 110 may be operable in a paired mode 132 where the in-car entertainment system is controlled by a separate electronic device such as a cellular telephone. In-car entertainment system 110 and/or the cellular telephone may have settings that enable the cellular telephone to automatically pair with in-car entertainment system 110 and enter the paired mode when within range. A user may enter a vehicle holding a cellular telephone that has previously paired with the in-car entertainment system. In response to the cellular telephone being present within the vehicle and the vehicle being powered on, the in-car entertainment system and cellular telephone may enter the paired mode 132 where the cellular telephone controls the user interface of the in-car entertainment system.

However, in some cases the in-car entertainment system may have multiple authorized cellular telephones that are set to enter the paired mode 132 when within range. For example, three users may enter a vehicle each holding a respective cellular telephone that has previously paired with the in-car entertainment system. Each cellular telephone individually would enter the paired mode 132 and control the user interface of the in-car entertainment system when the vehicle is turned on. However, because multiple authorized cellular telephones are present in the vehicle, the in-car entertainment system 110 does not know which cellular telephone to use for paired mode 132. Accordingly, the in-car entertainment system may refrain from entering the paired mode with any one of the cellular telephones. In other words, when multiple valid pairing options are available for the in-car entertainment system, the in-car entertainment system may pair with none of the valid options.

Alternatively, when multiple authorized cellular telephones are present in the vehicle, the in-car entertainment system 110 may default to entering the paired mode 132 with one of the in-range cellular telephones.

At step 604 attachment may be detected between one of the candidate power receiving devices and a power transmitting device. When the power receiving device 24 and the power transmitting device 12 are attached, the magnetic alignment structures 64 and 68 may be magnetically coupled and coils 36 and 48 may be aligned. In this configuration, the power transmitting device 12 may transfer wireless power to power receiving device 24.

During step 604, in arrangements where a power transmitting device is connected to a port in the in-car entertainment system, the in-car entertainment system 110 may use charging circuitry (e.g., charging circuitry 121 in FIG. 1) to power a wireless power transmitting coil in power transmitting device 12. In an arrangement where the wireless power transmitting coil is integrated with the in-car entertainment system, the charging circuitry may power the integrated wireless power transmitting coil without needing a user interfacing chord coupled to a port in the in-car entertainment system.

Any of the techniques discussed in connection with step 502 for detecting attachment between the power receiving device 24 and the power transmitting device 12 may be used in step 604. After detecting the attachment of the power receiving device and the power transmitting device, power transmitting device 12 may negotiate a power transfer rate with power receiving device 24 and begin delivering wireless power to power receiving device 24.

At step 606, the in-car entertainment system may enter the paired mode 132 with the power receiving device 24 that is attached to power transmitting device 12. Returning to the previous example, first, second, and third cellular telephones may be identified at step 602. The first cellular telephone has a first corresponding device identifier, the second cellular telephone has a second corresponding device identifier, and the third cellular telephone has a third corresponding device identifier. In-car entertainment system 110 may have the first, second, and third device identifiers on a list of authorized devices. At step 602, the in-car entertainment system 110 may detect the presence of the first, second, and third cellular telephones and confirm that all three cellular telephones are authorized devices for the paired mode. However, the in-car entertainment system does not enter the paired mode with any one of the cellular telephones. Alternatively, the in-car entertainment system may default to entering the paired mode with the first cellular telephone.

At step 604, the second cellular telephone may be attached to power transmitting device 12. At step 606, the in-car entertainment system may receive information (e.g., the device identifier for the second cellular telephone) indicating that the second cellular telephone has been attached to the power transmitting device. The in-car entertainment system may receive this information (e.g., the device identifier for the second cellular telephone) from the power transmitting device (e.g., via a wired connection) or from the second cellular telephone directly (e.g., via a wireless connection). In response to this information, the in-car entertainment system may enter the paired mode 132 with the second cellular telephone. In other words, the second cellular telephone may control the user interface of the in-car entertainment system.

To summarize, placing a given device of multiple candidate devices on the power transmitting device may serve to select the given device for the paired mode with the in-car entertainment system.

In some cases, a user may wish to disable this type of functionality. Therefore, a user-controllable setting may be present (e.g., on power receiving device 24, power transmitting device 12, and/or audiovisual electronic device 110) that enables the user to selectively enable and disable the automatic pairing. The user-controllable settings may allow the users to prioritize the candidate devices for entering paired mode 132. The priority of the devices may then dictate which device enters the paired mode instead of attachment to power transmitting device 12.

The steps of FIG. 6 have been described in connection with the example of an in-car entertainment system. However, these steps may apply to any other types of audiovisual electronic devices 110. As another example, consider the example where audiovisual electronic device 110 is a speaker. Multiple candidate devices may have previously paired with the speaker and configured to provide music to the speaker. Placing one of the candidate devices on the power transmitting device may determine which candidate device pairs with the speaker and controls the speaker.

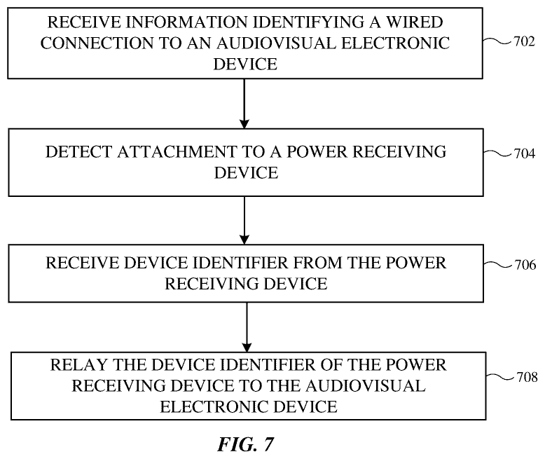

FIG. 7 is a flowchart of illustrative operations involved in operating a power transmitting device. At step 702, the power transmitting device 12 may receive information identifying a wired connection to an audiovisual electronic device. The information may identify the type of audiovisual electronic device to which the power transmitting device is connected. The power transmitting device 12 may be connected to a port 126 in the audiovisual electronic device.

At step 704, the power transmitting device 12 may detect attachment to a power receiving device 24. The attachment may be detected using measurement circuitry 41 and/or any other desired sensors.

After detecting attachment to the power receiving device, the power transmitting device may receive a device identifier from the power receiving device using in-band communication at step 706. The power transmitting device 12 may automatically receive the device identifier after being attached to the power receiving device. Alternatively, the power transmitting device 12 may transmit a request (e.g., using in-band communication) to the power receiving device 24 for the power receiving device to send device identifier information.

Additionally, after detecting attachment to the power receiving device, the power transmitting device 12 may begin delivering wireless power to the power receiving device.

At step 708, after receiving the device identifier for power receiving device 24 from power receiving device 24, the power transmitting device 12 may relay the device identifier to audiovisual electronic device 110 (e.g., using the wired connection to audiovisual electronic device 110). The audiovisual electronic device may use the device identifier to take additional steps (e.g., pair with the power receiving device) as desired.

The power transmitting device 12 may additionally transmit information regarding audiovisual electronic device 110 to power receiving device 24 (e.g., after attachment is detected at step 704). The power transmitting device 12 may transmit information regarding the audiovisual electronic device to power receiving device 24 using in-band communication, for example.

At any point subsequent to step 704 (when attachment to power receiving device 24 is detected), power transmitting device 12 may relay information between power receiving device 24 and audiovisual electronic device 110. Power transmitting device 12 may have a first (wireless, in-band) communications link with power receiving device 24 and a second (wired) communications link with audiovisual electronic device 110. Using these two communication links, power receiving device 24 and audiovisual electronic device 110 can communicate (through power transmitting device 12).

The steps of FIG. 7 may be executed by control circuitry in boot 98 of transmitting device 12 and/or housing 90 of transmitting device 12.

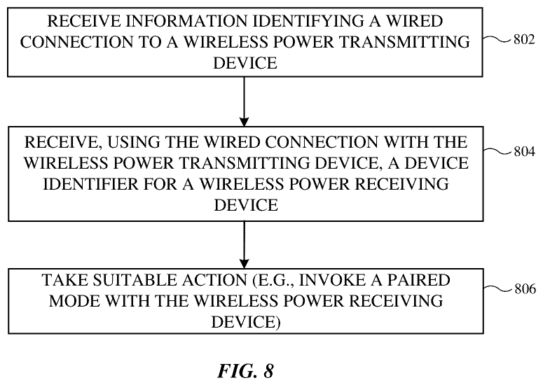

FIG. 8 is a flowchart of illustrative operations involved in operating audiovisual electronic device 110. At step 802, the audiovisual electronic device 110 may receive information identifying a wired connection to a wireless power transmitting device (e.g., a wireless charging puck). The information may identify the type of power transmitting device to which the audiovisual electronic device is connected. The power transmitting device 12 may be connected to a port 126 in the audiovisual electronic device. Audiovisual electronic device 110 may provide direct current power to the wireless power transmitting device 12 through port 126. Audiovisual electronic device 110 may provide the direct current power using a battery and/or using an AC-DC converter (such as AC-DC converter 14 in FIG. 1).

Next, at step 804, audiovisual electronic device 110 may receive, using the wired connection between audiovisual electronic device 110 and the wireless power transmitting device 12, a device identifier for a wireless power receiving device 24. The device identifier and/or other information provided by power transmitting device 12 may indicate that a power receiving device 24 is attached to the power transmitting device.

The example of receiving the device identifier for wireless power receiving device 24 using the wired connection to power transmitting device 12 is merely illustrative. Audiovisual electronic device 110 may also wirelessly receive the device identifier for wireless power receiving device 24 directly from wireless power receiving device 24 at step 804.

At step 806, audiovisual electronic device 110 may take suitable action based on the received device identifier. There are many possible actions that audiovisual electronic device 110 can take using this information. First, audiovisual electronic device 110 may compare the received device identifier to a list of authorized device identifiers to determine if the attached power receiving device 24 has previously paired to the audiovisual electronic device 110 (e.g., step 506 in FIG. 5). If it is determined that the attached power receiving device 24 has previously paired to the audiovisual electronic device 110 or authorization is received to pair the attached power receiving device to audiovisual electronic device 110 (e.g., step 508 in FIG. 5), then the power receiving device 24 and audiovisual electronic device 110 may pair and establish a communications link (e.g., step 510 in FIG. 5). After establishing the wireless communications link, audiovisual electronic device 110 may enter paired mode 132 where power receiving device 24 controls the user interface of audiovisual electronic device 110. In the paired mode, audiovisual electronic device 110 may receive an instruction from the wireless power receiving device 24 to present an audio or visual function supported by wireless power receiving device 24. Alternatively, after establishing the wireless communications link, audiovisual electronic device 110 and power receiving device 24 may be synced. As another example, at step 806, audiovisual electronic device 110 may use the received device identifier to select which one of multiple candidate devices to enter paired mode 132 (e.g., step 606 in FIG. 6).

At step 806, the audiovisual electronic device may display a user interface affordance on display 120. The user interface affordance may represent switching the audiovisual electronic device into the paired mode. In response to selection of the user interface affordance (e.g., by the user touching the user interface affordance on the touch-sensitive display 120), the audiovisual electronic device may switch operation (e.g., from the normal mode to the paired mode) to receive data representing audio or visual functions from the power receiving device 24.

At any point subsequent to step 804 (when attachment to power receiving device 24 is detected), audiovisual electronic device 110 may send information to power receiving device 24 through power transmitting device 12 (e.g., with device 12 acting as a relay). At any point, audiovisual electronic device 110 may wirelessly exchange information with power receiving device 24 directly. At any point subsequent to the wired connection between audiovisual electronic device 110 and power transmitting device 12 being established, audiovisual electronic device 110 may exchange information with power transmitting device 12 using the wired connection.

At step 806, audiovisual electronic device 110 may customize the user interface based on the received device identifier. In one, previously discussed example, audiovisual electronic device 110 customizes the user interface by allowing the power receiving device 24 to control the user interface. However, other arrangements are possible. For example, the audiovisual electronic device 110 may have stored preferences associated with the device identifier. In response to receiving the device identifier, the audiovisual electronic device 110 may revert to those stored preferences. Any type of preferences (e.g., volume levels, display settings, a preferred user interface appearance, etc.) may be associated with the device identifier. In cases where the audiovisual electronic device 110 is an in-car entertainment system, vehicle preferences (e.g., preset radio stations, seat position(s), cabin temperature, steering wheel position, mirror position(s), etc.) may also be associated with the device identifier. In response to receiving the device identifier, the audiovisual electronic device 110 may set the relevant components in the vehicle to the stored preferences for that device identifier. Additionally, one or more sensors (e.g., a camera, a three-dimensional image sensor such as a structured light sensor that emits beams of light, a proximity sensor, a gaze detection sensor, a fingerprint sensor, touch sensor, etc.) may also be included in audiovisual electronic device 110 to obtain additional information that is used to update any of the aforementioned settings in audiovisual electronic device 110 and provide a customized experience for the user.

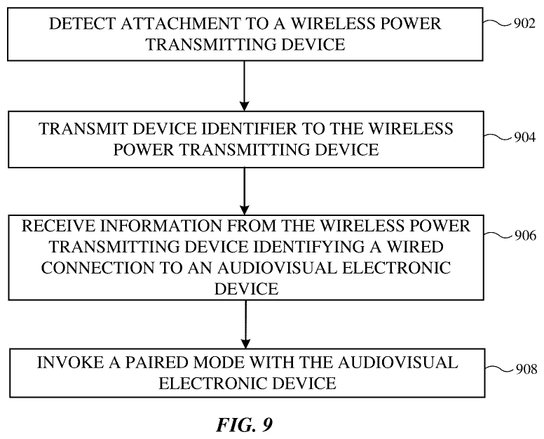

FIG. 9 is a flowchart of illustrative operations involved in operating a power receiving device. At step 902, the power receiving device 24 may detect attachment to a power transmitting device 12. The attachment may be detected using an NFC loop, a magnetic sensor, measurement circuitry 43 coupled to power receiving coil 48, and/or any other desired sensors.

After detecting attachment to the power transmitting device, the power receiving device 24 may transmit a device identifier to the power transmitting device using in-band communication (e.g., amplitude-shift keying) at step 904. The power receiving device 24 may automatically transmit the device identifier to the power transmitting device after being attached to the power transmitting device (e.g., in accordance with a wireless charging communications protocol). The power receiving device 24 may transmit the device identifier to the power transmitting device 12 after receiving information from the power transmitting device indicating that the power transmitting device is coupled to an audiovisual electronic device that is a pairing candidate. Alternatively, the power receiving device 24 may transmit the device identifier to power transmitting device 12 in response to receiving a request (e.g., using in-band communication) from the power transmitting device 12 for the power receiving device to send the device identifier information to the power transmitting device.

Additionally, at step 904, the power receiving device 24 may begin receiving wireless power from the power transmitting device.

At step 906, the power receiving device 24 may receive information from power transmitting device 12 identifying a wired connection between the power transmitting device and audiovisual electronic device 110. This example is merely illustrative. In some cases, step 906 may be omitted (e.g., the audiovisual electronic device 110 may communicate directly with power receiving device 24 instead of power transmitting device 12 notifying device 24 about the presence of audiovisual electronic device 110). The order of steps 904 and 906 may be switched in some arrangements.

Subsequently, at step 908, power receiving device 24 may invoke a paired mode with the audiovisual electronic device 110. The power receiving device 24 may ensure that the user has authorized the paired mode before entering the pair mode. For example, audiovisual electronic device 110 may be on an authorized list of devices to which power receiving device 24 should automatically pair. In this case, power receiving device 24 may enter the paired mode 132 with audiovisual electronic device 110 without seeking an additional authorization from the user. In another example where the audiovisual electronic device 110 is not on the authorized list of devices in device 24, audiovisual electronic device 110 and/or device 24 may display a request for authorization of pairing for the user. If the user authorizes the pairing, audiovisual electronic device 110 and device 24 enter the paired mode.

The example of step 908 is merely illustrative. In another example, the power receiving device 24 and audiovisual electronic device 110 may pair and establish a communications link (e.g., step 510 in FIG. 5) at step 908. The communications link may be a wireless communications link or a communications link using device 12 as a relay (as previously discussed). After establishing the communications link, audiovisual electronic device 110 may enter paired mode 132 where power receiving device 24 controls the user interface of audiovisual electronic device 110 (as previously discussed). Power receiving device 24 may send an instruction to the audiovisual electronic device 110 to present an audio or visual function supported by power receiving device 24. Alternatively, after establishing the communications link, audiovisual electronic device 110 and power receiving device 24 may be synced.

At any point subsequent to step 902 (when attachment to power receiving device 24 is detected), power receiving device 24 may send information to audiovisual electronic device 110 through power transmitting device 12. Additionally, in some arrangements, power receiving device 24 may wirelessly exchange information with audiovisual electronic device 110 directly. At any point subsequent to the attachment between power receiving device 24 and power transmitting device 12 being established, power receiving device 24 may exchange information with power transmitting device 12 using in-band communication (while power is delivered from device 12 to device 24).

It should be noted that the order of steps in FIGS. 5-9 is merely illustrative. If desired, the steps may be reordered, certain steps may be omitted, etc.

It should be noted that, in some cases, one or more of the aforementioned steps in FIGS. 5-9 may be performed without device 12 transmitting wireless power to device 24. As one possible scenario, device 24 may have a full battery when attached to device 12. Although device 12 may not enter a dedicated power transfer phase with device 24, the attachment between devices 12 and 24 may still trigger the establishment of a wireless communication link between device 24 and audiovisual electronic device 110. As another possible scenario, device 12 may not be configured to deliver wireless power. Device 12 may simply be a dock or other electronic device that magnetically attaches to device 24 and has a wired connection to audiovisual electronic device 110. Devices 12 and 24 may optionally communicate using antennas 62/66 instead of coils 36/48 in this type of scenario.

In-band communication between devices 12 and 24 is described in connection with many of the steps of FIGS. 5-9. It should be understood that any communication between devices 12 and 24 may optionally be performed out-of-band (e.g., using antennas 62/66 instead of coils 36/48).

The above-described technology contemplates communication between power transmitting device 12 and power receiving device 24 of information such as received power, states of charge, so forth, to control wireless power transfer, as well as information such as device type, device identifiers, so forth, to authorize pairing of devices for communication over protocols such as Bluetooth. It is contemplated that embodiments of the present technology may be implemented without the use of personally identifiable information. Out of an abundance of caution, it is noted that to the extent that any implementation of this technology involves the use of personally identifiable information, implementers should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users, for example, by offering opportunities for users to opt-in and/or opt-out of the sharing of information.

The foregoing is merely illustrative and various modifications can be made to the described embodiments. The foregoing embodiments may be implemented individually or in any combination.

What is claimed is:

1. An audiovisual electronic device, comprising:
charging circuitry configured to power a wireless power transmitting coil;
communications circuitry configured to receive at least audio or visual information from one or more in-range electronic devices; and
control circuitry operably coupled to the charging circuitry and the communications circuitry and configured to:
receive data representing one or more of audio or visual functions, using the communications circuitry, from a first in-range electronic device amongst a plurality of in-range electronic devices, when the wireless power transmitting coil is charging a wireless power receiver; and
receive data representing one or more of audio or visual functions, using the communications circuitry, from a second in-range electronic device amongst the plurality of in-range electronic devices, when the wireless power transmitting coil is not charging a wireless power receiver.

2. The audiovisual electronic device of claim 1, wherein the communications circuitry comprises wireless communications circuitry configured to communicate using an antenna that is different from the wireless power transmitting coil.

3. The audiovisual electronic device of claim 1, wherein the communications circuitry comprises wireless communications circuitry configured to communicate using the wireless power transmitting coil while the wireless power transmitting coil transmits wireless power signals to the wireless power receiver.

4. The audiovisual electronic device of claim 1, wherein the communications circuitry comprises wired communications circuitry configured to communicate using a connector.

5. The audiovisual electronic device of claim 1, wherein the first in-range electronic device is the wireless power receiver.

6. The audiovisual electronic device of claim 1, wherein the control circuitry is configured to:
in accordance with the wireless power transmitting coil initiating wireless power transmission to the wireless power receiver, switch operation of the audiovisual electronic device to receive data representing audio or visual functions from the wireless power receiver.

7. The audiovisual electronic device of claim 1, wherein the wireless power transmitting coil is adjacent to a magnetic alignment structure configured to align the wireless power transmitting coil with the wireless power receiver.

8. The audiovisual electronic device of claim 7, wherein the control circuitry is further configured to:
in accordance with detecting alignment of the wireless power receiver with the wireless power transmitting coil, switch operation of the audiovisual electronic device to receive data representing audio or visual functions from the wireless power receiver.

9. The audiovisual electronic device of claim 1, wherein the control circuitry is further configured to:
in accordance with the wireless power transmitting coil initiating wireless power transmission to the wireless power receiver, display a user interface affordance on a display of the audiovisual electronic device; and
in response to selection of the user interface affordance, switch operation of the audiovisual electronic device to receive data representing audio or visual functions from the wireless power receiver.

10. An audiovisual electronic device, comprising:
charging circuitry configured to power a wireless power transmitting coil;
communications circuitry operably coupled to the charging circuitry; and
control circuitry operably coupled to the charging circuitry and the communications circuitry and configured to:
receive, using the communications circuitry, audio or visual information from an electronic device when the wireless power transmitting coil is charging the electronic device; and
transmitting audiovisual information, using the communications circuitry, to the electronic device.

11. The audiovisual electronic device of claim 10, wherein the audiovisual information transmitted to the electronic device comprises audio information.

12. The audiovisual electronic device of claim 10, wherein the audiovisual information transmitted to the electronic device comprises video information.

13. The audiovisual electronic device of claim 10, wherein transmitting the audiovisual information to the electronic device comprises transmitting the audiovisual information to the electronic device using the wireless power transmitting coil.

14. A method of operating an audiovisual electronic device that comprises charging circuitry configured to power a wireless power transmitting coil, communications circuitry configured to receive at least audio or visual information from one or more in-range electronic devices, and control circuitry operably coupled to the charging circuitry and the communications circuitry, the method comprising:
receiving data representing one or more of audio or visual functions, using the communications circuitry, from a first in-range electronic device amongst a plurality of in-range electronic devices, when the wireless power transmitting coil is charging a wireless power receiver; and
receiving data representing one or more of audio or visual functions, using the communications circuitry, from a second in-range electronic device amongst the plurality of in-range electronic devices, when the wireless power transmitting coil is not charging a wireless power receiver.

15. The method of claim 14, wherein the communications circuitry comprises wireless communications circuitry configured to communicate using an antenna that is different from the wireless power transmitting coil.

16. The method of claim 14, wherein the communications circuitry comprises wireless communications circuitry configured to communicate using the wireless power transmitting coil while the wireless power transmitting coil transmits wireless power signals to the wireless power receiver.

17. The method of claim 14, wherein the communications circuitry comprises wired communications circuitry configured to communicate using a connector.

18. The method of claim 14, further comprising:
in accordance with the wireless power transmitting coil initiating wireless power transmission to the wireless power receiver, switching operation of the audiovisual electronic device to receive data representing audio or visual functions from the wireless power receiver.

19. The method of claim 14, wherein the wireless power transmitting coil is adjacent to a magnetic alignment structure configured to align the wireless power transmitting coil with the wireless power receiver and wherein the method further comprises:
in accordance with detecting alignment of the wireless power receiver with the wireless power transmitting coil, switching operation of the audiovisual electronic device to receive data representing audio or visual functions from the wireless power receiver.

20. The method of claim 14, further comprising:
in accordance with the wireless power transmitting coil initiating wireless power transmission to the wireless power receiver, displaying a user interface affordance on a display of the audiovisual electronic device; and
in response to selection of the user interface affordance, switching operation of the audiovisual electronic device to receive data representing audio or visual functions from the wireless power receiver.
